(19) United States
(12) Patent Application Publication
(10) Pub. No.: US 2016/0120735 A1
(43) Pub. Date: May 5, 2016

(54) MEDICAL NEGATIVE-PRESSURE CHAMBER WITH MOVABLE TABLE

(71) Applicant: WEYERGANS HIGH CARE AG, Düren (DE)

(72) Inventor: Rudolf WEYERGANS, Düren (DE)

(21) Appl. No.: 14/892,801

(22) PCT Filed: Aug. 29, 2014
(86) PCT No.: PCT/EP2014/068381

§ 371 Date: Nov. 20, 2015

(30) Foreign Application Priority Data
Sep. 24, 2013 (EP) 13185795.5

(51) Int. Cl. A61H 9/00

(52) U.S. Cl. CPC A61H 9/0057; A61H 2203/0443; A61H 2209/00

(57) ABSTRACT

A treatment device for medical and/or cosmetic therapy includes a negative-pressure chamber receiving a lower half of a person's body. The negative-pressure chamber is designed as a tube and has an admission opening sealed off from the person's body by a closure element. A first part of a table is arranged in the interior of the negative-pressure chamber. A second part of the table is arranged outside the negative-pressure chamber. The first part and the second part are each guided longitudinally on a linear guide. The first part can be moved at least partially out of the negative-pressure chamber and the second part can be moved away from the admission opening. A synchronization between the first part and the second part allows the first and second parts to be moved at the same speed in the same direction.

The invention pertains to a treatment device with a negative-pressure chamber for accommodating the lower half of the body of a person, wherein the negative-pressure chamber comprises an entrance opening, which can be sealed off gas-tight against the trunk of the person by means of a sealing element; the treatment device comprises a lying surface with a first part, arranged in the negative-pressure chamber, adapted to support the lower half of the body and a second part, arranged outside the negative-pressure chamber as an extension of the first part, to support the upper half of the body of the person; and, between the first part and the second part of the lying surface, an interruption is arranged, through which the sealing element can be brought into contact with the trunk of the person.

Such treatment devices with negative-pressure chambers for medical and/or cosmetic/physical therapy are known from EP 1 002 510 B1. They serve to enclose the lower half of the body of a person and to subject it to a defined, pulsating negative pressure. The pulsating negative pressure has the effect of stimulating blood circulation and of relieving the congestion of the lymphatic vessels.

The negative-pressure chamber, which is designed as a hollow cylinder, comprises an entrance opening at one end, which is sealed off against the trunk by a sealing element. A sealing element disclosed in DE 199 12 611 C2 comprises a flexible tube made of almost completely gas-impermeable material, one end of this tube being fastened to the negative-pressure chamber. By means of a ring attached to the other end of the tube, the tube is twisted until it rests tightly against the trunk.

A first part of a lying surface is arranged in the interior of the horizontally oriented negative-pressure chamber. A second part of the lying surface is arranged outside the negative-pressure chamber as an extension of the first part. Between the first and second parts of the lying surface, an interruption is provided, through which the sealing element can be brought into contact with the trunk of the person.

The therapy of patients with only limited mobility in such negative-pressure chambers can cause problems because of the difficulty of entering the negative-pressure chamber through the vertical entrance opening. Especially in the case of patients with no mobility at all, introducing the lower half of the body through the vertical entrance opening into the horizontally oriented negative-pressure chamber is almost impossible.

Against the background of this prior art, the goal of the invention is to create a treatment device with a negative-pressure chamber for medical and/or cosmetic/physical therapy which can also be used easily in particular by patients with limited mobility.

This goal is achieved with a treatment device of the type with the lying surface mentioned above in that both the first part and the second part of the lying surface are each guided on a linear guide so as to move longitudinally in the same direction, wherein the first part can be moved at least partially out of the negative-pressure chamber and the second part can be moved away from the entrance opening, and the treatment device comprises a system for synchronizing the first part and the second part of the lying surface, which is set up in such a way that it causes the first and second parts of the lying surface to move in the same direction at the same speed.

The split lying surface can be moved out of its base position into a receiving position, in which the lying surface is almost completely outside the negative-pressure chamber. In this receiving position, even a person with limited mobility, in particular a person whose body is in a fully stretched-out position, can be laid on the lying surface. Then the lying surface is pushed back into the base position, wherein the first part of the lying surface, on which the lower half of the person's body is resting, arrives in the negative-pressure chamber through the entrance opening.

The synchronization of the first and second parts of the lying surface has the effect that no relative movement occurs between the two parts during the time that they are being pushed into the base position for the performance of the negative-pressure treatment. The relatively narrow interruption between the first and second parts of the lying surface does not interfere with the comfort of the person lying on the lying surface. Especially when the sealing element according to DE 199 12 611 C2 comprises a flexible tube, which can be brought into contact with the trunk of the person by twisting, the first and second parts of the lying surface can be arranged at a distance of only a few centimeters from each other, wherein the tube can be brought into contact with the trunk of the person through the relatively narrow gap.

The two-part lying surface can be moved by hand or preferably by means of a drive out of the base position into the receiving position and back again along the path defined by the linear guide. The linear guide for the lying surface is preferably configured as a roller guide to reduce the forces necessary to move the lying surface; it comprises profiled sections, in which the rollers of a rolling slide can roll. The rolling slide comprises rollers, which are distributed in the longitudinal direction of the path of movement in correspondence with the load exerted on the lying surface, wherein preferably the rollers which are in the outer lower positions when in the installation position absorb the weight, whereas the middle roller, which is offset upwards, prevents the lying surface connected to the rolling slide from tilting in the profiled sections.

The drive which moves the lying surface is implemented in particular as a self-retaining linear drive such as a spindle. Because the drive is self-retaining, the lying surface is effectively held in place after the drive has been turned off, and thus any unintended movement of the lying surface is prevented and there is no need for an additional braking device.

To avoid injury which might be caused to the person by the movable lying surface, a safety clutch is arranged between the drive and the lying surface to interrupt the flow of force from the drive to the driven lying surface whenever a certain drive force is exceeded. The safety clutch preferably comprises at least one elastically deformable clutch element, which engages in a receiving opening in the other, cooperating part of the two connected parts. The elastically deformable clutch element is preferably configured as a conically tapering elastic peg, which engages in a ring-shaped opening. When the forces introduced into the safety clutch in the direction of the path in which the lying surface travels exceed a certain value, the conical elastic peg slides out of the ring-shaped receiving opening and interrupts the flow of force between the drive and the lying surface.

A switch element is preferably arranged at each receiving opening for an elastic clutch element, especially a clutch element in the form of a peg; the switch element can be in the form of a light barrier, for example, or a pushbutton switch. On the basis of the electrical signal produced by the switch element when the clutch engages, the switch element makes it is possible to confirm that the safety clutch has been properly engaged during the assembly of the lying surface. In addition, the switch element also cuts off the power supply to the drive as soon as the safety clutch responds.

The synchronization of the first and second parts of the lying surface is preferably achieved by means of two separate drives, especially by a first linear drive for the first part and a second linear drive for the second part of the lying surface, wherein the drives are controlled in such a way that they move the first and second parts of the lying surface at the same speed in the same direction.

Alternatively, the synchronization of the first and second parts of the lying surface can be achieved by a mechanical connection of the two parts, which temporarily connects the first and second parts of the lying surface to each other. To seal the negative-pressure chamber after the first part of the lying surface and thus the lower half of the body of the person have completely entered the chamber, the connection between the first and second parts must be disengaged. If, according to this embodiment of the invention, the first and second parts of the lying surface are connected mechanically while they are being moved, only one drive is necessary to move the entire lying surface.

The invention is explained in greater detail below on the basis of an exemplary embodiment:

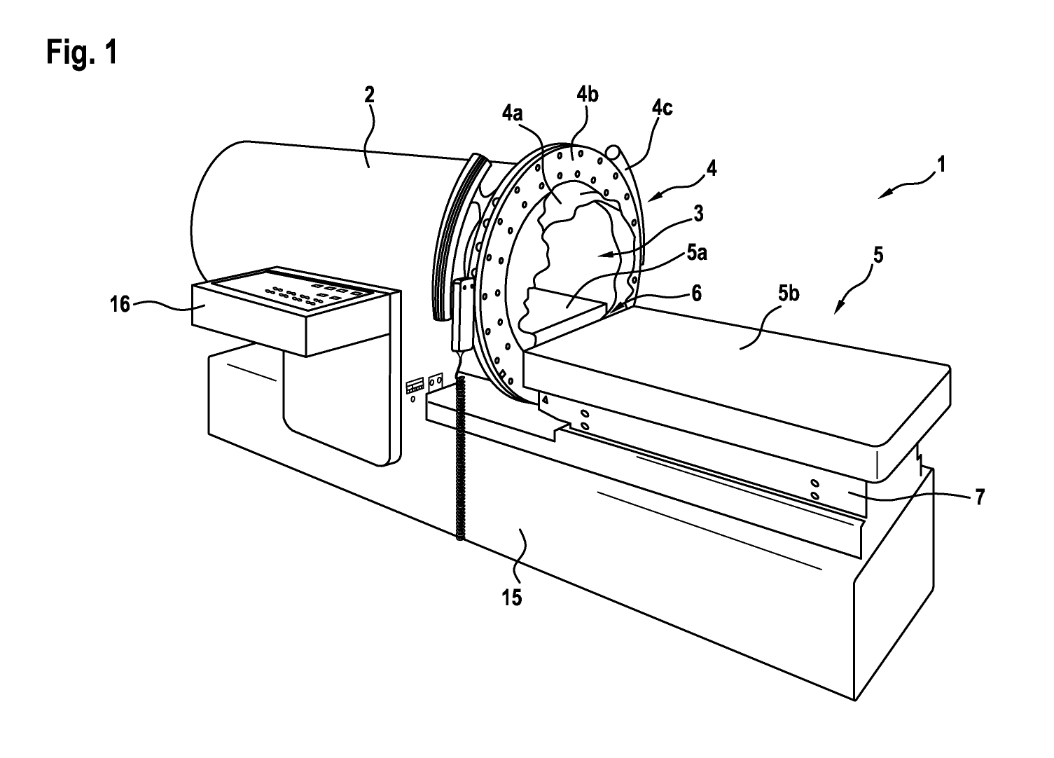

FIG. 1 shows a perspective view of a treatment device according to the invention with a lying surface in the base position;

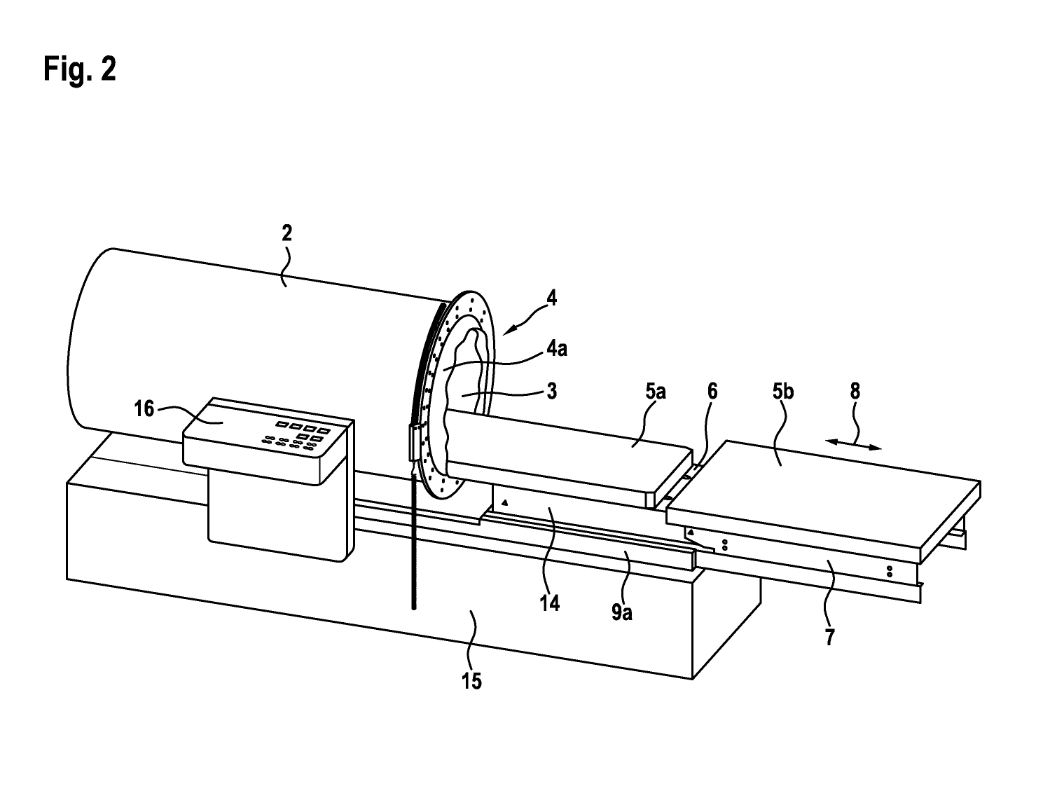

FIG. 2 shows the treatment device according to FIG. 1 with the lying surface in the receiving position;

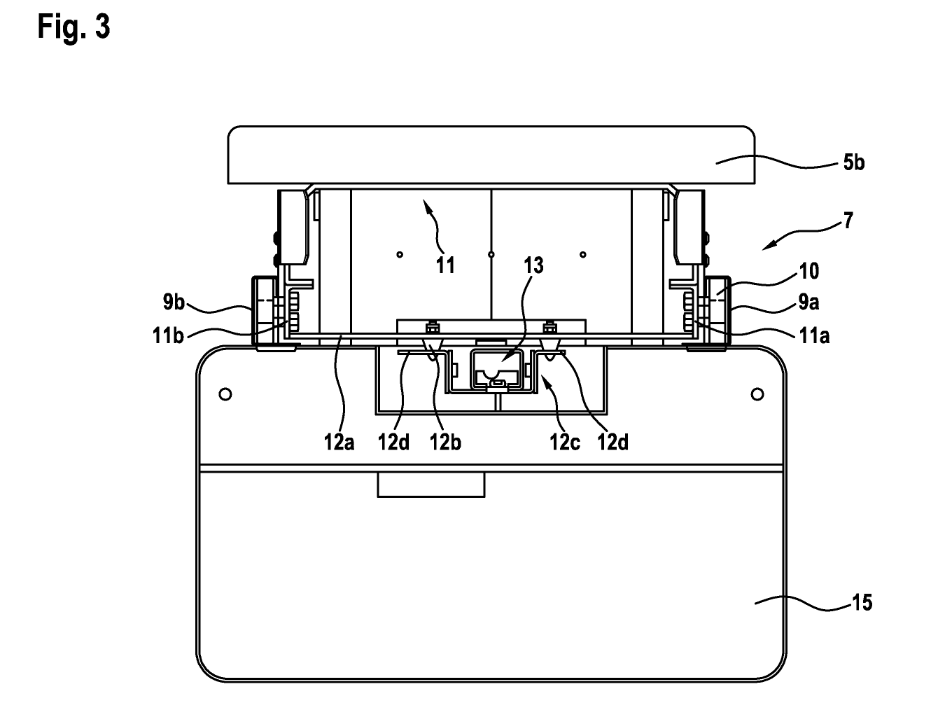

FIG. 3 shows a front view of the treatment device according to FIGS. 1 and 2;

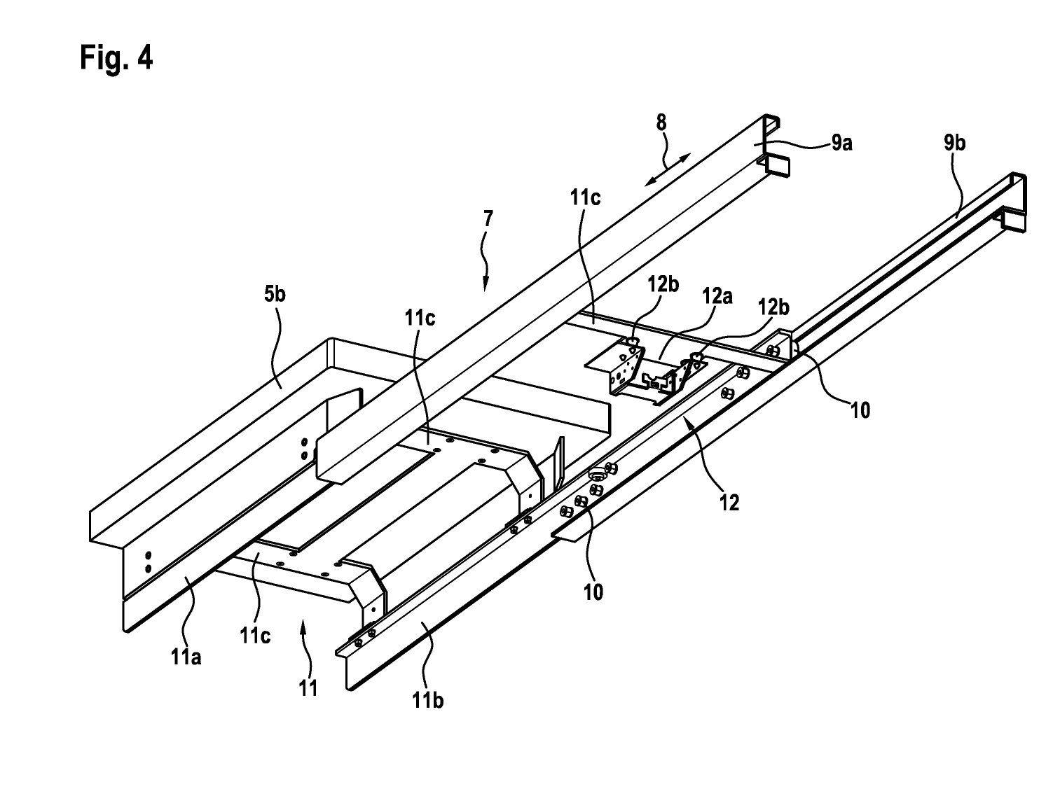

FIG. 4 shows a perspective view, from below, of the second part of the lying surface; and

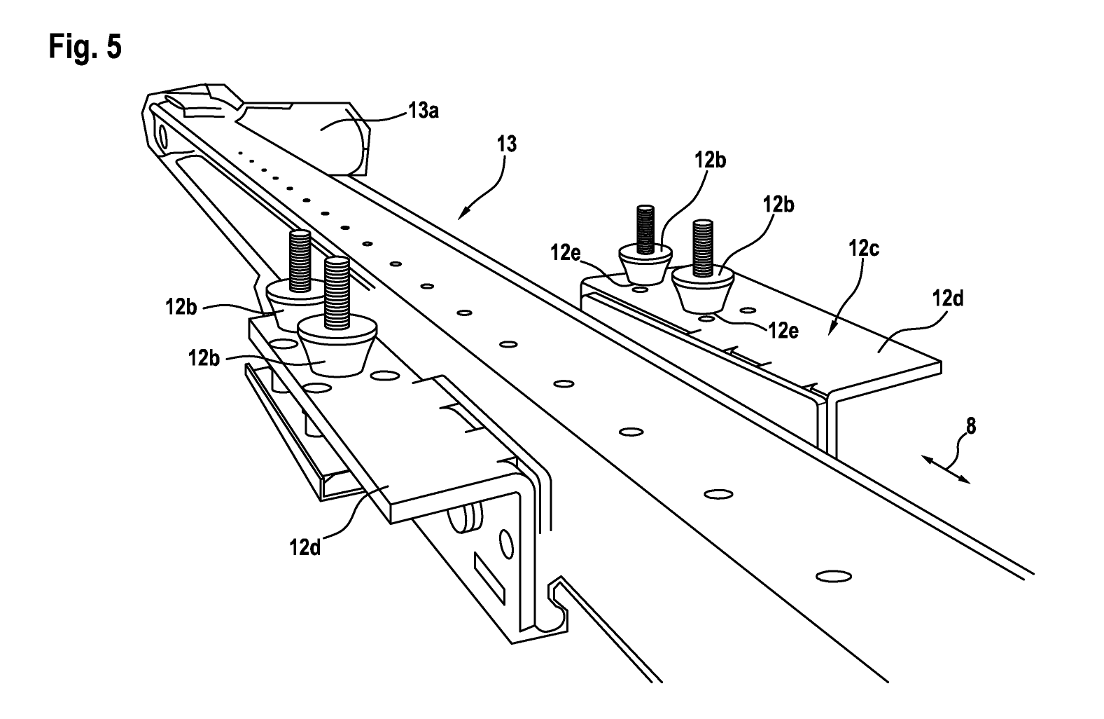

FIG. 5 shows a perspective view of a drive for the lying surface.

FIG. 1 shows a treatment device 1 with an elongated, hollow, cylindrical negative-pressure chamber 2 for accommodating the lower half of the body of a person (not shown for the sake of clarity) to be treated. At one of the two ends of the negative-pressure chamber there is an entrance opening 3, which can be sealed off gas-tight against the trunk of the person to be treated. The sealing element 4 comprises a flexible tube 4a of almost completely gas-impermeable material, which is fastened at one end to the entrance opening 3 and at the other end to a rotation ring 4b. Rotation grips 4c are attached to the outer edge of the rotation ring. To seal off the negative-pressure chamber 2 against the trunk of the person in a gas-tight manner, the tube surrounds the trunk of the person to be treated. By rotating the tube by means of the rotation ring 4b, the tube is twisted, as a result of which the tube becomes tightly wrapped around the trunk.

The negative-pressure chamber 2 is connected to a negative-pressure generator (not shown), in particular a vacuum pump. The negative-pressure chamber comprises means for generating a negative-pressure profile. These means comprise in particular a control unit for setting the length of time during which the negative-pressure generator is activated and possibly for controlling its operating level. Finally, the means comprise at least one actuatable venting valve for the negative-pressure chamber. These means can be used to produce a negative-pressure profile, in which the pressure in the negative-pressure chamber is lowered by a maximum of 80 mbars versus atmospheric, ambient pressure and alternates between the lowered pressure and atmospheric pressure. Alternatively, the pressure in the negative-pressure chamber is lowered by 35-80 mbars versus the atmospheric, ambient pressure and then increased by 20-60 mbars. As a result, the negative pressure in the first negative-pressure chamber alternates between a first, higher, negative-pressure value and a second, lower, negative-pressure value.

The negative-pressure chamber 2 is mounted on a stand 15 of the treatment device 1. A control panel 16 for the treatment device is also mounted on the stand 15.

The treatment device 1 also comprises a horizontally oriented lying surface 5 with a first part 5a arranged inside the negative-pressure chamber 2 when in the base position and a second part 5b, which forms an extension of the first part 5a and is arranged outside the negative-pressure chamber 2 when in the base position.

The first part 5a has such a length and such a width that it is adapted to support the lower half of the body of the person to be treated. The second part 5b has such a length and such a width that it is adapted to support the upper half of the person to be treated. Between the first part 5a and the second part 5b of the lying surface 5 is an interruption 6, especially easy to see in FIG. 2, in the form of a gap dividing the lying surface 5 transversely to the lengthwise direction. In the base position shown in FIG. 1, the tube 4a of the sealing element 4 passes through the gap and is arranged on the person to be treated so that it rests flush on the trunk.

Both the first part 5a and the second part 5b of the lying surface 5 are guided so as to move in the same longitudinal direction, wherein the first part 5a can be moved at least partially out of the base position shown in FIG. 1 and thus out of the negative-pressure chamber 2, and the second part 5b can be moved away from the entrance opening 3, as shown in FIG. 2. FIG. 2 shows the lying surface 5 in its receiving position, in which a person with limited mobility can be easily laid on the lying surface 5.

The structure of the linear guide 7 is explained in greater detail below on the basis of FIGS. 3 and 4. The linear guide 7 is implemented as a roller guide and comprises guide sections 9a, 9b extending in the direction of the path 8 along which the lying surface moves; rollers 10 of a rolling slide 11 roll along these guide sections. The rolling slide 11 consists of two longitudinal bars 11a, 11b, extending parallel to the guide sections 9a, 9b; these bars are connected to each other by several transverse bars 11c. The second part 5b of the lying surface is screwed to the horizontally extending sections of the transverse bars 11c which are at the rear with respect to the insertion direction. The rollers 10 are rotatably supported on the sections of the longitudinal bars 11a, 11b which are in the front with respect to the insertion direction, so that the lying surface 5b can be pulled out as if it were a drawer. The rollers 10 are rotatably supported on the longitudinal bars 11a, 11b of the rolling slide 11 with an offset in the longitudinal direction of the longitudinal path 8, wherein the two rollers on each side of the rolling slide 11 which are in the lower position when in the installation position absorb the weight of the person lying on the lying surface 5b, and at least one roller, shifted vertically upward, on each side of the rolling slide 11 prevents the rolling slide from tipping in the guide sections 9a, 9b.

A clutch plate 12a of a safety clutch 12, which is oriented horizontally when in the installation position, is provided on the transverse bar 11c which is at the front with respect to the insertion direction. The safety clutch 12 connects the rolling slide 11 to a linear drive 13, shown overall in FIG. 5, for moving the part 5b of the lying surface 5 along the path 8 defined by the linear guide 7. The safety clutch 12 comprises four elastically deformable clutch elements 12b, which are configured as conically tapering pegs of elastic material. The downward-pointing tips of the pegs project vertically downward from the clutch plate 12a.

The linear drive 13 comprises a drive motor 13a, which, by means of a spindle (not shown), moves a U-shaped second clutch component 12c back and forth in the direction of the path 8. The clutch component 12c comprises two horizontal sections 12d, which are located on the same horizontal plane in alignment with each other. In each of the two horizontal sections 12d, two receiving openings 12e are provided, which are arranged one behind the other in the direction of the path 8. The distance between these openings corresponds to the distance between the clutch elements 12b, so that these elements can engage from above in the receiving openings 12e and thus allow forces to flow between the linear drive 13 and the rolling slide 11.

When the drive force transmitted by the linear drive 13 by way of the clutch elements 12b in the direction of the path 8 exceeds a certain value determined by the structural design of the safety clutch 12, the clutch elements 12b slip out of the receiving openings 12e and cut off the flow of force between the linear drive 13 and the rolling slide 11.

The first part 5a of the lying surface 5 is also guided by a linear guide of similar design and can move back and forth in the direction of the path 8 from the base position into the receiving position and from the receiving position back into the base position by means a separate linear drive. In addition, the first part 5b is also connected by a safety clutch to its own linear drive. The structure of the safety clutch is the same as that of the safety clutch for the second part 5b of the lying surface, so that reference can be made to the description given above.

The two linear drives 13 for the first and second parts 5a, 5b of the lying surface 5 are synchronized with each other by a control system in such a way that the two linear drives 13 move the first and second parts of the lying surface 5 at the same speed and in the same direction. As a result of the synchronous movement of the first and second parts 5a, 5b of the lying surface 5, the size of the interruption 6 does not change, and thus the comfort of the person to be treated is not impaired during the movement of the lying surface from the base position into the receiving position or vice versa.

In the receiving position shown in FIG. 2, the section of the first part 5a of the lying surface 5 projecting beyond the longitudinal bars is supported on a guide table 14 in order to reduce the bending moments in the guide sections (not shown) for the first part 5a of the lying surface.

List of Reference Symbols

| No. | Name |
|---|---|
| 1 | treatment device |
| 2 | negative-pressure chamber |
| 3 | entrance opening |
| 4 | sealing element |
| 4a | tube |
| 4b | rotation ring |
| 4c | rotation grips |
| 5 | lying surface |
| 5a | first part |
| 5b | second part |
| 6 | interruption |
| 7 | linearguide |
| 8 | path of movement |
| 9a, b | guide sections |
| 10 | rollers |
| 11 | rolling slide |
| 11a, b | longitudinal bars |
| 11c | transverse bar |
| 12 | safety clutch |
| 12a | clutch plate |
| 12b | clutch elements |
| 12c | clutch component |
| 12d | horizontal section |
| 12e | receiving openings |
| 13 | linear drive |
| 13a | drive motor |
| 14 | guide table |
| 15 | base frame |

1.-9. (canceled)

10. A treatment device, comprising:
a negative-pressure chamber for accommodating a lower half of a body of a person, the negative pressure chamber having an entrance opening;
a sealing element configured to provide a gas-tight seal between the entrance opening and a trunk of the person;
a table with a first part arranged in the negative-pressure chamber and adapted to support the lower half of the body and a second part arranged outside the negative-pressure chamber as an extension of the first part and adapted to support the upper half of the body of the person; and
an interruption, through which the sealing element can be brought into contact with the trunk of the person, is provided between the first part and the second part of the table;
a linear guide on which both the first part and the second part of the table are each guided longitudinally in the same direction, such that the first part is movable at least partially out of the negative-pressure chamber and the second part is movable away from the entrance opening; and
a synchronizing device synchronizing the first part and the second part of the table, the synchronizing device being configured to move the first part and the second part of the table in the same direction at the same speed along the liner guide.

11. The treatment device according to claim 10, wherein the synchronizing device includes at least one drive configured to move the table along the linear guides.

12. The treatment device according to claim 10, wherein the linear guide is configured as a roller guide.

13. The treatment device according to claim 11, wherein each said at least one drive is a self-retaining drive.

14. The treatment device according to claim 11, further comprising a safety clutch between each said at least one drive and the table, each safety clutch interrupting a flow of force between said at least one drive and a driven part of the table when a drive force limit is exceeded.

15. The treatment device according to claim 14, wherein each said safety clutch comprises a first elastically deformable clutch element engaging a receiving opening in a second clutch element.

16. The treatment device according to claim 15, wherein a switch element is arranged in each receiving opening, which, upon engagement of the first elastically deformable clutch element in the receiving opening, completes a circuit.

17. The treatment device according to claim 11, wherein the synchronizing device comprises at least one first drive for the first part and at least one second drive for the second part of the table, the at least one first drive and the at least one second drive being controlled such that the first part and the second part of the table move at the same speed and in the same direction.

18. The treatment device according to claim 11, wherein the synchronizing device comprises a mechanical clutch that temporarily connects the first and second parts of the table.
